(19) United States
(12) Patent Application Publication
(10) Pub. No.: US 2008/0118858 A1
(43) Pub. Date: May 22, 2008

(54) PROCESS FOR PRODUCING PHOTO-CONDUCTORS

(75) Inventors: Shigenori YUUYA, Ashigarakami-gun (JP); Katsuhiro KOHDA, Ashigarakami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 11/943,749

(22) Filed: Nov. 21, 2007

(30) Foreign Application Priority Data
Nov. 21, 2006 (JP) 314502/2006

(51) Int. Cl. G03G 5/08

(52) U.S. Cl. 430/133

(57) ABSTRACT

A polycrystalline photo-conductor containing Bi₁₂MO₂₀, in which M represents at least one kind of element selected from the group consisting of Ge, Si, and Ti, is produced by hydrothermal synthesis processing. The photo-conductor is adapted for constituting a radiation imaging panel capable of recording radiation image information.

### BACKGROUND OF THE INVENTION

1. Field of the Invention

This invention relates to a process for producing a photo-conductor, which may be utilized for constituting a radiation imaging panel adapted for use in a radiation imaging apparatus, such as an X-ray imaging apparatus.

2. Description of the Related Art

There have heretofore been proposed X-ray imaging panels designed for use in a medical X-ray image recording operation, such that a radiation dose delivered to an object during the medical X-ray image recording operation may be kept small, and such that the image quality of an image and its capability of serving as an effective tool in, particularly, the efficient and accurate diagnosis of an illness may be enhanced. With the proposed X-ray imaging panels, a photo-conductor sensitive to X-rays is employed as a photosensitive material. The photo-conductor is exposed to X-rays carrying X-ray image information, and an electrostatic latent image is thereby formed on the photo-conductor. Thereafter, the electrostatic latent image, which has been formed on the photo-conductor, is read out by use of light or a plurality of electrodes. The techniques utilizing the X-ray imaging panels have advantages over the known photo-fluorography utilizing TV image pickup tubes in that an image is capable of being obtained with a high resolution.

Specifically, when X-rays are irradiated to a charge forming layer located in the X-ray imaging panel, electric charges corresponding to X-ray energy are formed in the charge forming layer. The thus formed electric charges are read out as an electric signal. The photo-conductor described above acts as the charge forming layer. As the material for the photo-conductor, amorphous selenium has heretofore been used. However, ordinarily, amorphous selenium has the problems in that it is necessary for the layer thickness of the photo-conductor to be set to be large (e.g., at least 500 μm) because of a low radiation absorptivity.

However, if the layer thickness of the photo-conductor is set to be large, the problems will occur in that the speed, with which the electrostatic latent image is read out, becomes low. Also, the problems will occur in that, since a high voltage is applied across the photo-conductor at least during a period from the beginning of the read-out operation after the formation of the electrostatic latent image to the end of the read-out operation, a dark current becomes large, electric charges occurring due to the dark current are added to the latent image charges, and the contrast in a low dose region becomes low. Further, since the high voltage is applied across the photo-conductor, device deterioration is apt to occur, durability becomes low, and electric noise is apt to occur.

Furthermore, amorphous selenium has toxicity and exhibits a glass transition temperature of approximately 43° C. At temperatures higher than approximately 43° C., amorphous selenium is set in a metastable state, in which crystallization proceeds, and therefore a marked alteration of the characteristics occurs with the passage of time. Accordingly, amorphous selenium has the problems in that particular management is necessary at the time of use and at the time of storage.

Because of the problems described above, it has been studied to utilize materials for the photo-conductor other than amorphous selenium. In, for example, U.S. Patent Application Publication No. 20050214581, there has been proposed a radiation imaging panel using a particle coating film or a sintered film utilizing Bi₁₂MO₂₀, in which M represents at least one kind of element selected from the group consisting of Ge, Si, and Ti. It is described therein that, in cases where the photo-conductor takes on the form of a polycrystal, the efficiency with which electric charges having been generated are collected is capable of being enhanced, electric noise is capable of being kept low, and the sensitivity is capable of being enhanced.

Processes for producing a Bi₁₂MO₂₀ single crystal have been proposed in, for example, “Hydrothermal growth of bismuth silicate (BSO)”, J. Larkin et al., Journal of Crystal Growth, Vol. 128, pp. 871-875, 1993, “Characterization of Czochralski- and hydrothermal-grown Bi₁₂SiO₂₀”, W. B. Leigh et al., Journal of Applied Physics, Vol. 76, No. 2, pp. 660-666, 1994, and U.S. Pat. No. 5,322,591. With the proposed processes, a Bi₁₂SiO₂₀ single crystal, which has been prepared with a melting technique (a Czochralski technique, hereinbelow referred to as the CZ technique), is utilized as a seed crystal and a raw material crystal for hydrothermal synthesis processing. Specifically, the proposed processes comprise: locating the raw material crystal on a lower side within an autoclave for hydrothermal synthesis processing, hanging the seed crystal on an upper side within the autoclave by use of a silver wire, introducing an aqueous NaOH solution having a predetermined concentration into the vessel, setting the temperatures of the entire region so as to fall within the range of 360° C. to 400° C., setting a temperature gradient such that the temperature of the lower side is lower by 5° C. to 25° C. than the temperature of the upper side, and thereby causing the Bi₂SiO₂₀ single crystal to deposit little by little on the surface of the seed crystal located on the upper side.

With the processes for producing a Bi₁₂MO₂₀ single crystal proposed in “Hydrothermal growth of bismuth silicate (BSO)”, J. Larkin et al., Journal of Crystal Growth, Vol. 128, pp. 871-875, 1993, “Characterization of Czochralski- and hydrothermal-grown Bi₁₂SiO₂₀”, W. B. Leigh et al., Journal of Applied Physics, Vol. 76, No. 2, pp. 660-666, 1994, and U.S. Pat. No. 5,322,591, the Bi₁₂SiO₂₀ single crystal is utilized as a seed crystal. With the aforesaid processes, it is not always possible to form a material having a large area, which material will be appropriate for the photo-conductor for use in the radiation imaging panel. Also, in “Hydrothermal growth of bismuth silicate (BSO)”, J. Larkin et al., Journal of Crystal Growth, Vol. 128, pp. 871-875, 1993, “Characterization of Czochralski- and hydrothermal-grown Bi₁₂SlO₂₀”, W. B. Leigh et al., Journal of Applied Physics, Vol. 76, No. 2, pp. 660-666, 1994, only the measurement of photo-conduction with visible light with respect to the Bi₁₂SiO₂₀ single crystal is described, and nothing is described with respect to the photo-conduction with X-rays. Further, U.S. Pat. No. 5,322,591 is limited to a process for synthesizing a nonlinear optical single crystal of bismuth silicate for use in optical storage and optical signal processing.

As for image formability of the radiation imaging panel, it is necessary for the sensitivity to be enhanced through the enhancement of the electric charge collecting efficiency as described above, and it is markedly important to obtain image stability at the time of iterated image recording and read-out operations. Particularly, in the cases of X-ray images for medical diagnosis, if a ghost or an alteration of gray level gradation contrast arises during the iterated image recording and read-out operations, an erroneous diagnosis will be caused to occur. Therefore, it is important for the ghost and the alteration of gray level gradation contrast to be suppressed.

The image ghost and the alteration of contrast are caused to occur by a decrease of intensity of a signal obtained from a radiation detecting element, which decrease arises due to iterated irradiation of radiation, or by the occurrence of a residual signal after the irradiation of the radiation. As for the photo-conductor constituting the radiation detecting element, the foregoing means that an electric current generated by the irradiation of the radiation alters, and that the electric current at the time other than the irradiation of the radiation alters.

### SUMMARY OF THE INVENTION

The primary object of the present invention is to provide a process for producing a photo-conductor for constituting a radiation imaging panel, wherein problems of a radiation imaging panel with regard to a ghost and an alteration of contrast are capable of being eliminated substantially, and wherein a photo-conductor for radiation detection, which photo-conductor has a large area, is capable of being produced.

The present invention provides a process for producing a photo-conductor, comprising the steps of:

producing a polycrystalline photo-conductor containing Bi₁₂MO₂₀, in which M represents at least one kind of element selected from the group consisting of Ge, Si, and Ti, by hydrothermal synthesis processing, the photo-conductor being adapted for constituting a radiation imaging panel capable of recording radiation image information.

The process for producing a photo-conductor in accordance with the present invention should preferably be modified such that, at the time of the hydrothermal synthesis processing, a seed layer containing a polycrystal of Bi₁₂MO₂₀, in which M represents at least one kind of element selected from the group consisting of Ge, Si, and Ti, is formed on a base plate, and

a polycrystal of Bi₁₂MO₂₀, in which M represents at least one kind of element selected from the group consisting of Ge, Si, and Ti, is caused to grow on the seed layer. (Hereinbelow, M represents at least one kind of element selected from the group consisting of Ge, Si, and Ti.)

Ordinarily, the term “polycrystal” means a solid, which is constituted of an aggregate of single crystals having different orientations. Also, the term “polycrystal” as used herein means a solid, in which a plurality of crystal particles taking on the form of the single crystals varying in orientation have been aggregated densely, and in which adjacent crystals have been bonded or bound with one another. The term “polycrystal” as used herein means the solid, in which a binder constituted of an organic material, a polymer material, or an inorganic material is not contained.

Also, the process for producing a photo-conductor in accordance with the present invention should preferably be modified such that a noble metal or a noble metal alloy has been coated as a primary coat under the seed layer of the base plate. Further, the process for producing a photo-conductor in accordance with the present invention may be modified such that an entire area of surfaces of the base plate has been coated with a noble metal or a noble metal alloy. The term “noble metal” as used herein means Au, Ag, Pt, Pd, Rh, Ir, Ru, or Os. Also, the term “noble metal alloy” as used herein means the substance, in which at least one kind of metal or a nonmetal has been added to Au, Ag, Pt, Pd, Rh, Ir, Ru, or Os, and which has noble metal-like characteristics.

The process for producing a photo-conductor in accordance with the present invention comprises the steps of: producing the polycrystalline photo-conductor containing Bi₁₂MO₂₀, in which M represents at least one kind of element selected from the group consisting of Ge, Si, and Ti, by the hydrothermal synthesis processing, the photo-conductor being adapted for constituting the radiation imaging panel capable of recording the radiation image information. Therefore, with the process for producing a photo-conductor in accordance with the present invention, it is possible to suppress the occurrence of a ghost or an alteration of gray level gradation contrast during the iterated image recording and read-out operations. Also, with the process for producing a photo-conductor in accordance with the present invention, it is possible to keep a high electric charge collecting efficiency and good sensitivity. Further, with the process for producing a photo-conductor in accordance with the present invention, wherein the polycrystalline photo-conductor is produced, it is possible to form the radiation imaging panel having a large area, which is not capable of being formed with a single crystal.

With the modification of the process for producing a photo-conductor in accordance with the present invention, wherein the noble metal or the noble metal alloy has been coated as the primary coat under the seed layer of the base plate, which is used at the time of the hydrothermal synthesis processing, the noble metal layer located between the base plate and the seed layer is capable of being utilized as an electrode of the radiation imaging panel. Therefore, in such cases, the radiation imaging panel is capable of being produced more appropriately.

In cases where the entire area of the surfaces of the base plate has been coated with the noble metal or the noble metal alloy, and the seed layer is formed on one side surface of the coating layer of the noble metal or the noble metal alloy, it becomes possible to prevent the problems from occurring in that a small amount of the base plate material dissolves out inevitably at the time of the hydrothermal synthesis processing, and that the characteristics of the photo-conductor are adversely affected by contamination of Bi₁₂MO₂₀ having been formed. Also, in such cases, the formation of Bi₁₂MO₂₀ with the hydrothermal synthesis processing occurs substantially only on the seed layer, and therefore the rate with which Bi₁₂MO₂₀ is formed is capable of being kept high.

The present invention will hereinbelow be described in further detail with reference to the accompanying drawings.

### BRIEF DESCRIPTION OF THE DRAWINGS

FIG. 1 is a schematic sectional view showing an example of a producing apparatus used for carrying out an embodiment of the process for producing a photo-conductor in accordance with the present invention,

FIG. 2 is a schematic sectional view showing an example of coating of a base plate,

FIG. 3 is a schematic sectional view showing a different example of coating of a base plate,

FIGS. 4A through 4F are explanatory views showing steps in Example 1, and

FIGS. 5A through 5G are explanatory views showing steps in Example 2.

### DETAILED DESCRIPTION OF THE INVENTION

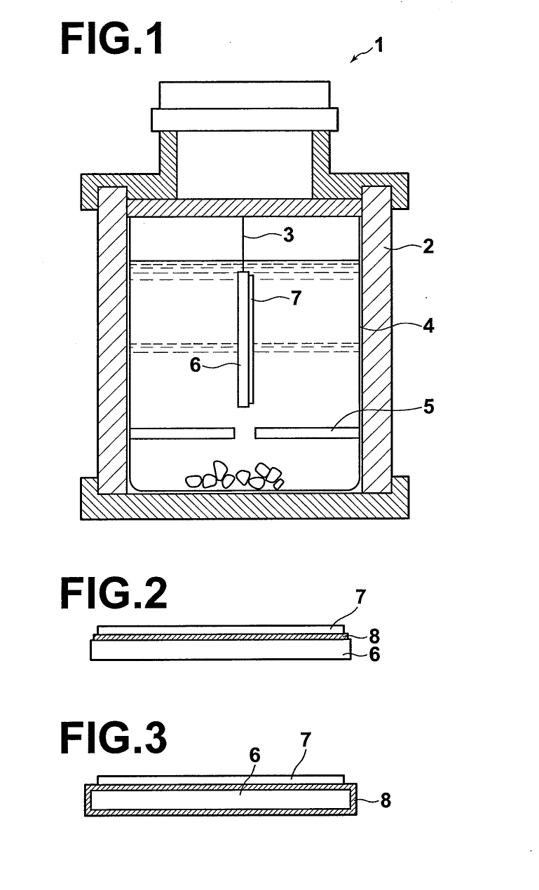

FIG. 1 is a schematic sectional view showing an example of a hydrothermal synthesis processing apparatus used for carrying out an embodiment of the process for producing a photo-conductor in accordance with the present invention. With reference to FIG. 1, a hydrothermal synthesis processing apparatus 1 comprises an autoclave 2. The hydrothermal synthesis processing apparatus 1 also comprises a wire 3 fitted to an upper wall of the autoclave 2 in order to hang a base plate 6 provided with a seed layer 7 (a seed crystal). The hydrothermal synthesis processing apparatus 1 further comprises a vessel 4 located within the autoclave 2. A baffle (a perforated plate) 5 is located within the vessel 4. The baffle 5 is used to suppress convection of an aqueous solution, which convection is caused to occur by a difference in temperature between a raw material region and a seed layer region.

The autoclave 2 may have a strength capable of enduring a high temperature and a high pressure. The vessel 4 may be made from an arbitrary material, which does not undergo reaction with the aqueous solution. By way of example, the vessel 4 may have a stainless steel inner wall provided with lining with a noble metal, such as Pt or Ag.

The process for producing a photo-conductor in accordance with the present invention may be carried out with processing, wherein the raw material is introduced into the vessel 4, wherein the base plate 6 provided with a seed layer 7 is hung from the wire 3 and located within the autoclave 2, and wherein the raw material having been dissolved in the aqueous solution is caused to deposit on the seed layer 7. As the raw material, it is possible to use previously synthesized Bi₁₂MO₂₀ in the state of particles or a bulk material. Alternatively, it is possible to use a mixture of Bi₂O₃ and GeO₂, SiO₂, or TiO₂ in a Bi/M molar ratio falling within the range of 11 to 13.

The seed layer 7 may be prepared with processing, wherein Bi₁₂MO₂₀ particles are formed into a film with a screen printing technique, a doctor blade technique, or the like, and wherein the thus formed film of the Bi₁₂MO₂₀ particles is sintered. Alternatively, Bi₁₂MO₂₀ having been formed into a film on the base plate with a CVD technique, a PVD technique, a chemical liquid phase technique, or the like, may be used as the seed layer.

The base plate 6 may be made from an arbitrary material, which does not undergo reaction with an alkaline solution at high temperatures and high pressures. Examples of materials appropriate for the base plate 6 include alumina, aluminum nitride, silicon carbide, silicon nitride, noble metals, and alloys of noble metals. As illustrated in FIG. 2, in cases where the base plate 6 made from a material other than the noble metals and the alloys of the noble metals is employed, a noble metal layer 8 acting as a primary coat layer may be formed between the base plate 6 and the seed layer 7. In such cases, as described above, the noble metal layer 8 located between the base plate 6 and the seed layer 7 is capable of being utilized as the electrode for the radiation imaging panel. In such cases, the photo-conductor, which constitutes the radiation imaging panel, contains the seed layer 7. However, the thickness of the seed layer 7 is markedly smaller than the thickness of Bi₁₂MO₂₀ having been formed with the hydrothermal synthesis processing, and therefore the adverse effects occurring upon the imaging characteristics are negligible. Also, the base plate material, which has a density lower than the density of Bi₁₂MO₂₀, exhibits low X-ray absorption and has little effect upon the sensitivity of the photo-conductor. Therefore, the base plate region need not necessarily be removed with polishing processing and may be utilized as a strength retaining member or a passivation member.

As illustrated in FIG. 3, the coating with the noble metal layer 8 may be performed over the entire area of the surfaces of the base plate 6, and the seed layer 7 may be formed on one surface of the base plate 6, which surface has been coated with the noble metal layer 8. In cases where the noble metal layer 8 is thus formed over the entire area of the surfaces of the base plate 6, it is possible to prevent the problems from occurring in that a small amount of the base plate material inevitably dissolves out at the time of the hydrothermal synthesis processing, and it is thus possible to prevent the problems from occurring in that the characteristics of Bi₁₂MO₂₀ having been formed are affected by contamination. Also, in such cases, the formation of Bi₁₂MO₂₀ with the hydrothermal synthesis processing occurs substantially only on the seed layer 7, and therefore the rate with which Bi₁₂MO₂₀ is formed is capable of being kept high. Further, as in the cases described above, the seed layer 7, the noble metal layer 8 acting as the primary coat under the seed layer 7, and the base plate material are capable of being utilized directly as the materials for constituting the radiation imaging panel.

The aqueous solution for dissolving the raw material should preferably be an alkaline aqueous solution. By way of example, the aqueous solution for dissolving the raw material may be an aqueous LiOH solution, an aqueous NaOH solution, an aqueous KOH solution, or an aqueous ammonia solution. The concentration of the aqueous solution should preferably fall within the range of approximately 2N to approximately 6N, and should more preferably fall within the range of approximately 4N to approximately 5N.

A hydrothermal synthesis film is capable of being obtained under the growth conditions such that the temperature at the raw material region is set so as to fall within the range of 300° C. to 500° C., and such that the temperature at the deposition region on the seed layer is set at a value lower by 0° C. to 50° C. than the temperature at the raw material region. In cases where the temperature at the raw material region is high, or in cases where the difference in temperature between the raw material region and the deposition region on the seed layer is large, the rate with which the film is formed becomes high, and the denseness of the obtained film is apt to become low. The temperature at the raw material region should preferably be set so as to fall within the range of 380° C. to 420° C., and the temperature at the deposition region on the seed layer should preferably be set at a value lower by 5° C. to 10° C. than the temperature at the raw material region. In such cases, a denser film is capable of being obtained.

The photo-conductor in accordance with the present invention may be employed for a radiation imaging panel for a TFT technique. With the TFT technique, the electric charges having been generated with the irradiation of the radiation are accumulated, and the accumulated electric charges are read through an operation, in which an electric switch, such as a thin film transistor (TFT), is turned on and off with respect to each of pixels. The photo-conductor in accordance with the present invention may also be employed for a radiation imaging panel for a radiation imaging panel for an optical read-out technique, in which the read-out operation is performed by use of a radiation image detector utilizing a semiconductor material capable of generating the electric charges when the semiconductor material is exposed to light.

The present invention will further be illustrated by the following non-limitative examples.

### EXAMPLES

### Example 1

(Preparation of a Slurry)

Bismuth oxide (Bi₂O₃) particles having a purity of 5N and silicon oxide (SiO₂) particles having a purity of 5N were mixed together such that a molar ratio might become equal to 6:1. The resulting mixture was thereafter subjected to ball mill mixing processing and was then subjected to preliminary firing processing at a temperature of 800° C. for five hours. In this manner, single phase Bi₁₂SiO₂₀ was obtained from the solid phase reaction. The thus obtained Bi₁₂SiO₂₀ was then coarsely ground by use of a mortar. The Bi₁₂SiO₂₀ particles having thus been obtained were then subjected to grinding processing in ethanol with a ball mill by use of zirconium oxide balls, and the particles having a mean particle diameter of 2 μm were thus obtained. Thereafter, 4 wt % of polyvinyl butyral (PVB) acting as a binder and 0.5 wt % of dioctyl phthalate acting as a plasticizer were added. The resulting mixture was further mixed with ethanol, and a slurry having a viscosity of 60 poise was thereby obtained.

(Preparation of an aluminum oxide plate provided with a Bi₁₂SiO₂₀ polycrystal film acting as a seed layer)

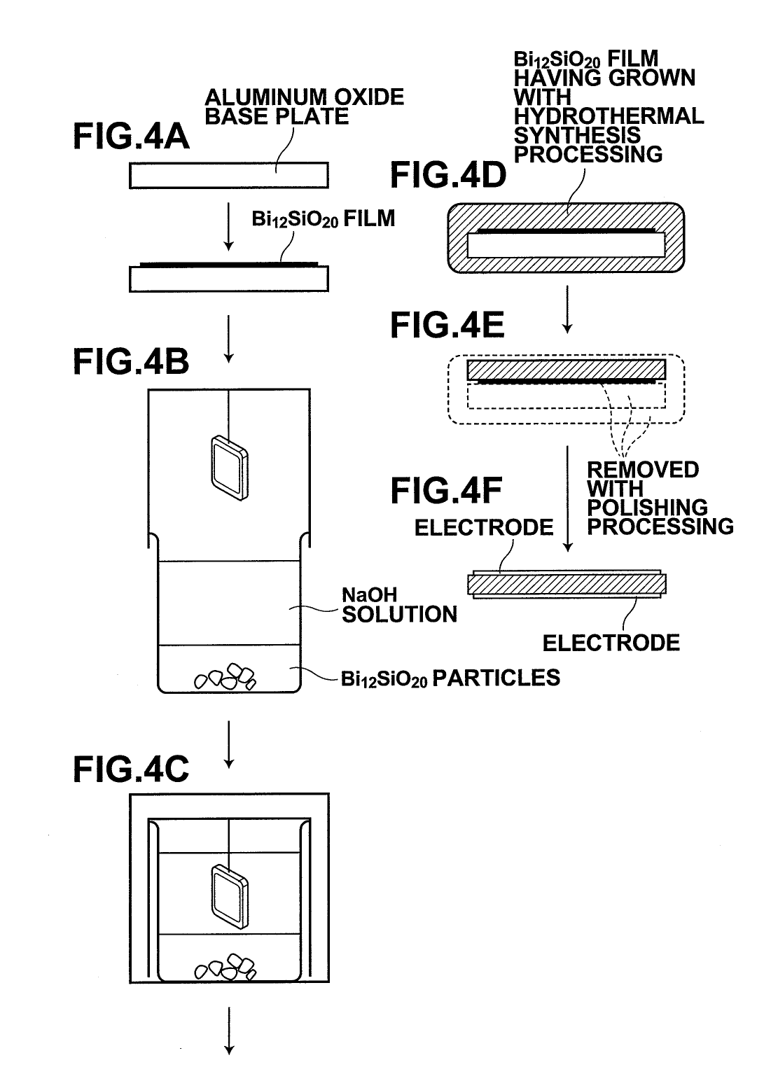

The slurry having the adjusted viscosity was coated to a small thickness with a doctor blade onto one surface side of an aluminum oxide sintered material base plate (thickness: 0.4 mm, purity: 95%, silicon oxide content: 2.7%). Thereafter, the coating layerwas left to stand at the room temperature for 24 hours and was thus dried. The coating layer was then subjected to binder removal processing in an air atmosphere at a temperature of 600° C. for two hours. (With the binder removal processing, the binder was vaporized with burning and removed.) The coating layer was thereafter subjected to firing processing in an argon atmosphere at a temperature of 850° C. for one hour. In this manner, a Bi₁₂SiO₂₀ polycrystal film was obtained on the aluminum oxide sintered material base plate. The thickness of the Bi₁₂SiO₂₀ polycrystal film acting as the seed layer was approximately 10 μm. (Reference may be made to FIG. 4A.)

(Preparation for Hydrothermal Synthesis Processing)

A Bi₁₂SiO₂₀ single crystal having been prepared with the Czochralski technique was ground, and the Bi₁₂SiO₂₀ particles having thus been obtained were introduced into a platinum cylinder. Further, an aqueous NaOH solution having been adjusted to a concentration of 4N was introduced into the cylinder up to a 80% height of the cylinder. (Reference may be made to FIG. 4B.) Furthermore, the aluminum oxide plate provided with the Bi₁₂SiO₂₀ polycrystal film acting as the seed layer, which plate had been prepared in the manner described above, was hung by a platinum wire from a platinum cylinder cover. The aluminum oxide plate provided with the Bi₁₂SiO₂₀ polycrystal film was then slowly inserted into the cylinder, such that the entire area of the aluminum oxide plate provided with the Bi₁₂SiO₂₀ polycrystal film might be immersed into the upper side of the aqueous NaOH solution contained in the cylinder. The cylinder cover was thus closed. (Reference may be made to FIG. 4C.) Thereafter, the cylinder was inserted into an autoclave, and a heater controller was adjusted, such that the temperature of the upper side might be kept at 390° C. and such that the temperature of the lower side might be kept at 400° C. The state described above was kept for 30 days.

(Polishing Processing)

The sample having been taken out from the autoclave was in the state, in which a Bi₁₂SiO₂₀ polycrystal film had been deposited on the seed layer surface of the base plate, the opposite surface of the base plate, and the side faces of the base plate. (Reference may be made to FIG. 4D.) Each of the thickness of the Bi₁₂SiO₂₀ polycrystal film on the seed layer surface and the thickness of the Bi₁₂SiO₂₀ polycrystal film on the opposite surface was equal to approximately 300 μm. However, the Bi₁₂SiO₂₀ polycrystal film having been deposited on the surface opposite to the seed layer surface took on the form of a cloudy porous film. By use of a circular disk type polishing machine, polishing processing was performed from one side of the flat surface, while water was being applied. Firstly, the cloudy porous Bi₁₂SiO₂₀ polycrystal film having been deposited on one side was removed with the polishing processing. The polishing processing was further continued, and the aluminum oxide base plate was removed with the polishing processing. Furthermore, the 10 μm-thick Bi₁₂SiO₂₀ polycrystal film acting as the seed layer, which film had been formed with the firing processing, was removed with the polishing processing. Also, the sample was turned over, and the growth surface of Bi₁₂SiO₂₀ having been formed with the hydrothermal synthesis processing was polished. In this manner, a smooth Bi₁₂SiO₂₀ polycrystal film having a thickness of 200 μm was obtained. (Reference may be made to FIG. 4E.)

(Formation of Electrodes)

Au electrodes were formed with sputtering processing on opposite surfaces of the Bi₁₂SiO₂₀ polycrystal film having been obtained in the manner described above. In this manner, an X-ray detection sample provided with the Bi₁₂SiO₂₀ polycrystal film as the photo-conductor was completed. (Reference may be made to FIG. 4F.)

### Example 2

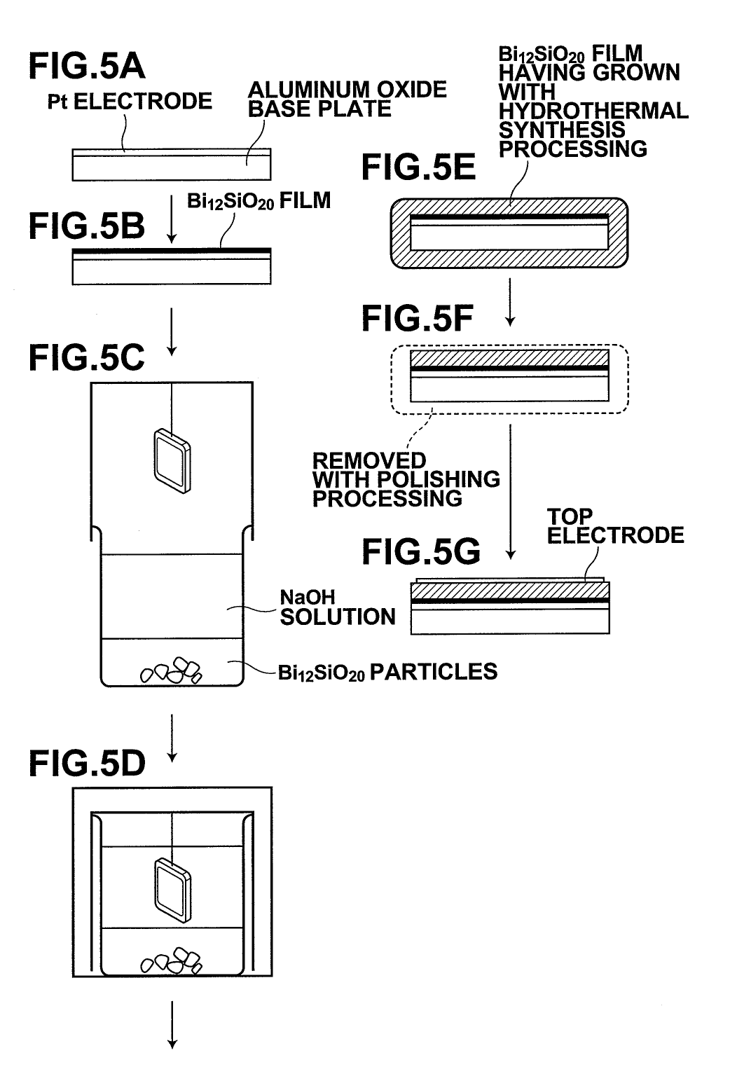

An aluminum oxide plate provided with a Bi₁₂SiO₂₀ polycrystal film acting as a seed layer was prepared in the same manner as that in Example 1, except that a Pt (platinum) electrode having a thickness of 0.1 μm was previously formed with sputtering processing on one surface of the aluminum oxide base plate (reference may be made to FIG. 5A), and except that a Bi₁₂SiO₂₀ polycrystal film was then formed on the Pt electrode (reference may be made to FIG. 5B). Thereafter, the same steps as those in Example 1 were performed. (Reference may be made to FIGS. 5C and 5D.) the state of the sample obtained after the hydrothermal synthesis processing was approximately identical with the state of the sample in Example 1. (Reference may be made to FIG. 5E.) The sample having been taken out from the autoclave was polished until the thickness of the aluminum oxide base plate became equal to 200 μm. Also, the sample was turned over, and the growth surface of Bi₁₂SiO₂₀ having been formed with the hydrothermal synthesis processing was polished until the film thickness of the Bi₁₂SiO₂₀ film became equal to 200 μm. (Reference may be made to FIG. 5F.) Finally, a top electrode was formed, and an X-ray detection sample was completed. (Reference may be made to FIG. 5G.)

### Example 3

Such that Bi₁₂SiO₂₀ might be prevented from being contaminated with a small amount of an element due to dissolution of aluminum oxide during the hydrothermal synthesis processing, an Au layer having a thickness of 0.1 μm was formed with vacuum evaporation processing on the entire area of the surfaces of aluminum oxide base plate (i.e., all of the front surface, the rear surface, and end faces of the aluminum oxide base plate). Thereafter, the slurry having been prepared in the same manner as that in Example 1 was coated onto the Au layer and was then subjected to firing processing. Also, a Bi₁₂SiO₂₀ film was formed with the hydrothermal synthesis processing in the same manner as that in Example 1. The film having thus been formed was such that the Bi₁₂SiO₂₀ film was formed on the seed layer alone, and such that little Bi₁₂SiO₂₀ clung to the Au exposed parts. Also, the film thickness of the Bi₁₂SiO₂₀ film having been obtained on the seed layer was equal to approximately 400 μm, and the rate of growth was thus higher than the rate of growth in Example 1 and Example 2. The Bi₁₂SiO₂₀ film was polished in the same manner as that in Example 2 (with the base plate and Au of the Bi₁₂SiO₂₀ film being kept remaining). Finally, an Au top electrode was formed, and an X-ray detection sample was completed.

### Comparative Example 1

A base plate, which was provided with a Pt primary coat and a seed layer, was prepared in the same manner as that in Example 2, except that the thickness of the seed layer was set to be at least 200 μm, and except that each of the aluminum oxide base plate and the seed layer was polished to a thickness of 200 μm. The seed layer was utilized directly as a photo-conductor, and the Pt primary coat layer was utilized as a bottom electrode. A top electrode was then formed, and an X-ray detection sample was thus formed.

### Comparative Example 2

The Bi₁₂SiO₂₀ single crystal, which had been prepared with the Czochralski technique for use as the raw material in hydrothermal synthesis processing in each of Examples 1, 2, and 3, was polished to a thickness of 200 μm. Electrodes were then formed on the opposite surfaces of the thus polished Bi₁₂SiO₂₀ single crystal, and an X-ray detection sample was thus formed.

(Evaluation of Sensitivity)

With respect to each of the X-ray detection samples, which had been obtained in Examples 1, 2, and 3 and Comparative Examples 1 and 2, a voltage of 500V was applied across the X-ray detection sample, and 1 mR (milliroentgen) X-rays (produced by a tungsten tube, under the condition of a voltage of 70 kV, with a 21 mm Al filter being used) were irradiated to the X-ray detection sample for 70 millisecond. A photo-current flowing across the two electrodes at this time was converted into a voltage by use of a current amplifier, and the voltage was measured with a digital oscilloscope. In accordance with the obtained current-time wave form, integration was made within the range of the X-ray irradiation time, and the quantity of the collected electric charges per sample area was taken as the sensitivity.

(Sensitivity Alteration Rate)

With respect to each of the X-ray detection samples, which had been obtained in Examples 1, 2, and 3 and Comparative Examples 1 and 2, a voltage of 500V was applied across the X-ray detection sample, and 300 mR (milliroentgen) X-rays (produced by a tungsten tube, under the condition of a voltage of 80 kV, without an Al filter being used) were irradiated to the X-ray detection sample for 700 millisecond. The irradiation was iterated ten times in total at intervals of 15 seconds. A photo-current flowing across the two electrodes at this time was converted into a voltage by use of a current amplifier, and the voltage was measured with a digital oscilloscope. In accordance with the obtained current-time wave form, integration was made within the range of the first X-ray irradiation time, and the quantity of the collected electric charges was calculated. Also, integration was made within the range of the tenth X-ray irradiation time, and the quantity of the collected electric charges was calculated. The percentage of the collected electric charge quantity obtained at the time of the tenth X-ray irradiation with respect to the collected electric charge quantity obtained at the time of the first X-ray irradiation was taken as the sensitivity alteration rate.

The results shown in Table 1 below were obtained.

TABLE 1

| | | Sensitivity |
|---|---|---|
| | Sensitivity | alteration rate |
| | (pC/mR · cm²) | (%) |
| Example 1 | 4800 | 94 |
| Example 2 | 4500 | 93 |
| Example 3 | 4900 | 96 |
| Comparative | 2800 | 35 |
| Example 1 | | |
| Comparative | 4200 | 63 |
| Example 2 | | |

As clear from Table 1, the Bi₁₂SiO₂₀ polycrystal, which had been produced with the hydrothermal synthesis processing, exhibited a high sensitivity and little decrease in sensitivity. Each of the samples having been obtained in Examples 1 and 2 exhibited a sensitivity and a sensitivity alteration rate, which were slightly lower than the sensitivity and the sensitivity alteration rate of the sample having been obtained in Example 3. As for each of the samples having been obtained in Examples 1 and 2, it was thus considered that the dissolution of a small amount of the base plate material and contamination of the film formed with the hydrothermal synthesis processing might occur. However, as for each of the samples having been obtained in Examples 1 and 2, the sensitivity alteration rate had been enhanced markedly than the sensitivity alteration rate of the single crystal in Comparative Example 2. Therefore, with the process for producing a photo-conductor in accordance with the present invention, it is possible to obtain the photo-conductor containing Bi₁₂MO₂₀, which is capable of suppressing the occurrence of the ghost or the alteration of gray level gradation contrast due to a decrease in sensitivity during the iterated image recording and read-out operations.

Also, with the process in accordance with Example 2 or Example 3, the base plate material and the primary coat noble metal layer are capable of being utilized as the support base material and the electrode for the radiation imaging panel, and a radiation imaging panel having a large area is capable of being produced more easily.

What is claimed is:

1. A process for producing a photo-conductor, comprising the steps of:
producing a polycrystalline photo-conductor containing Bi₁₂MO₂₀, in which M represents at least one kind of element selected from the group consisting of Ge, Si, and Ti, by hydrothermal synthesis processing, the photo-conductor being adapted for constituting a radiation imaging panel capable of recording radiation image information.

2. A process for producing a photo-conductor as defined in claim 1 wherein a seed layer containing a polycrystal of Bi₁₂MO₂₀, in which M represents at least one kind of element selected from the group consisting of Ge, Si, and Ti, is formed on a base plate, and a polycrystal of Bi₁₂MO₂₀, in which M represents at least one kind of element selected from the group consisting of Ge, Si, and Ti, is caused to grow on the seed layer.

3. A process for producing a photo-conductor as defined in claim 2 wherein a noble metal or a noble metal alloy has been coated as a primary coat under the seed layer of the base plate.

4. A process for producing a photo-conductor as defined in claim 2 wherein an entire area of surfaces of the base plate has been coated with a noble metal or a noble metal alloy.
